(19) United States
(12) Patent Application Publication
(10) Pub. No.: US 2010/0235211 A1
(43) Pub. Date: Sep. 16, 2010

(54) RECRUITING COMPENSATION MODEL

(76) Inventors: Stephen J. Williams, Beverly Hills, CA (US); Denise K. Williams, Beverly Hills, CA (US)

Correspondence Address: PERKINS COIE LLP, POST OFFICE BOX 1208, SEATTLE, WA, 98111-1208, US

(21) Appl. No.: 12/403,219

(22) Filed: Mar. 12, 2009

(51) Int. Cl. G06Q 10/00; G06Q 50/00; G06Q 30/00

(52) U.S. Cl. 705/8; 705/11; 705/400; 705/34

(57) ABSTRACT

A method for compensating a searcher that presents a candidate for hire to a client, wherein the candidate receives annual compensation and is eligible for delayed compensation, includes the following: calculating a Stage I searcher fee based on a percentage of the candidate's annual compensation, wherein the percentage is a first percentage if the candidate is presented to the client by a first predetermined date, and a second percentage if the candidate is presented to the client by a second predetermined date; calculating a Stage II searcher fee based on a percentage of the candidate's delayed compensation, wherein the percentage is a function of a candidate performance rating that is given after the candidate has been employed for a predetermined amount of time; and compensating the searcher with the Stage I and Stage II searcher fees. The method may optionally be implemented in a system and/or via a computer readable medium.

### BACKGROUND

A search firm, such as an executive search firm, includes one or more individuals who recruit candidates to fill executive or other top level positions for client companies and other organizations. Client companies and other organizations (hereinafter referred to as “clients”) often hire search firms in lieu of conducting the search themselves. One reason clients do this is to save the time and money that would otherwise be spent performing the search themselves. Another reason is that search firms often have expertise and a large network of potential candidates with the requisite knowledge and skill to meet the needs of a client looking for a candidate with a specific technical background or particular qualifications. Additionally, other common methods of attracting talented people for executive positions, such as placing “want ads,” often do not attract qualified applicants because candidates who may be open to the possibility of changing companies often do not have the time to look for or respond to advertisements, or may be concerned about repercussions if their employers were to find out they were actively seeking employment.

Executive search firms typically charge client companies or organizations either on a contingency fee basis or on a retained agreement basis. When a contingency fee basis is employed, the client generally does not pay the search firm until a candidate is actually hired.

Retained agreements are often used when a client is interested in recruiting a person with particular qualities and qualifications for a specific position. When a client elects to conduct a retained search, a retainer fee is paid to the search firm regardless of whether a candidate is ultimately hired. The focus of a retained search is typically on the quality of a candidate, not the quantity of candidates. The retained firm often spends considerable time ascertaining the client's requirements for the particular position, as well as their goals, other needs, expectations, culture, personality, and business strategy in order to ensure that candidates who are presented will fit well in the position.

Typically, fees for retained searches are based on a percentage of a hired candidate's first year cash compensation, which may include a base salary, actual sign-on bonuses, and estimated performance bonuses. Unlike contingent searches, at least a portion of such fees is commonly made upfront. A common payment scheme for retained searches is based on time milestones, wherein payments are due and paid on pre-determined dates, before a candidate is actually hired. It is common for a large majority of the fees to be due and paid before a candidate is hired, regardless of the progress of the search.

Because they typically require fees to be paid upfront, many current retained search models used in the market provide little accountability for the search firm to deliver qualified candidates in a swift manner. In addition, the upfront payments are often based on estimated performance bonus pay, which fees are often non-refundable, even if a hired candidate never realizes such bonus. This arrangement places much of the risk of the candidate becoming a quality, long term employee on the client.

### SUMMARY

In one embodiment, a method for compensating a searcher includes providing a fee structure based on recruiting milestones and a candidate performance rating, and providing a payment schedule based on a set of performance milestones of the searcher. The fee structure optionally has two stages. Stage I dictates the fees paid during the recruitment process, and is based on a percentage of a hired candidate's annual compensation. Stage II dictates the fees paid once a hired candidate has been employed for a full performance review cycle, and is based on a percentage of delayed compensation, optionally determined by a candidate performance rating. The payment schedule is optionally dictated by performance milestones that may include signing a retainer agreement, presentation of one or more candidates acceptable to the client, an accepted offer of employment by a candidate, or successful employment of a candidate for a predetermined amount of time.

In another embodiment, a searcher compensation model is implemented via a computer-readable medium that provides a user interface for determining searcher compensation.

In another embodiment, a recruiting compensation system includes means for receiving a series of data, means for calculating a Stage I searcher fee based on a percentage of a candidate's annual compensation, means for calculating a Stage II searcher fee based on a percentage of the candidate's delayed compensation, means for preparing a payment schedule, and means for generating a report to reflect the status of the payment schedule.

Other features and advantages will appear hereinafter. The features described above can be used separately or together, or in various combinations or one or more of them.

### BRIEF DESCRIPTION OF THE FIGURES

FIG. 1 illustrates Stage I of a recruitment compensation model fee structure according to one embodiment, which is based on two recruiting milestones and annual compensation.

FIG. 2 illustrates Stage II of a recruitment compensation model fee structure according to one embodiment, which is based on a candidate performance rating and delayed compensation, and is dependent on a third recruiting milestone occurring.

FIG. 3. illustrates a payment schedule for a recruitment compensation model according to one embodiment, which is based on performance milestones.

### DETAILED DESCRIPTION

Various embodiments will now be described. The following description provides specific details for a thorough understanding and enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments.

The terminology used in the description presented below is intended to be interpreted in its broadest reasonable manner, even though it is being used in conjunction with a detailed description of certain specific embodiments. Certain terms may even be emphasized below; however, any terminology intended to be interpreted in any restricted manner will be overly and specifically defined as such in this detailed description section.

Where context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

In order for the compensation model to be more completely understood, some definitions are set forth below. Such definitions are meant to encompass any equivalents.

A “client” is a company or individual seeking one or more candidates to fill one or more employment positions.

A “searcher” is a recruiting firm or search firm or company, such as an executive search firm, or an individual hired by a client to find one or more candidates suitable to fill one or more of the client's employment positions.

“Annual compensation” is the projected cash compensation to be paid within a candidate's first year of employment, including base salary and any sign-on bonus. Annual compensation generally does not include equity, long-term incentives, relocation, or other reimbursed expenses.

“Delayed compensation” is any cash bonus or other compensation actually paid, or to be paid, to a candidate based on the candidate's performance rating after a full performance review cycle. The client will typically provide documentation of the delayed compensation and the candidate performance rating to the searcher.

A “fall-off candidate” is a candidate who is presented to a client for a position specified in a retainer agreement, but who is hired by the client for an additional specified position or for a different position not specified within the retainer agreement.

“Candidate performance ratings” are ratings given to a hired candidate by a client. The candidate performance ratings may include two or more tiers (referred to herein as Tier 1, Tier 2, etc.), for example, to be given after a full performance review cycle. The tiers are typically defined by the client. A Tier 1 candidate performance rating, as used herein, refers to the highest rating a hired candidate or employee can be given by the client.

In one embodiment, the recruitment compensation model includes a fee structure based on recruiting milestones and candidate performance ratings, and a payment schedule based on performance milestones. The fee structure includes at least two stages, referred to herein as Stage I and Stage II. Stage I provides an incentive for the searcher to produce candidates quickly, while Stage II provides a shared risk between the searcher and the client in the hired candidate's actual job performance. The payment schedule generally reflects the searcher's ability to produce results satisfactory to the client more so than conventionally structured payment schedules.

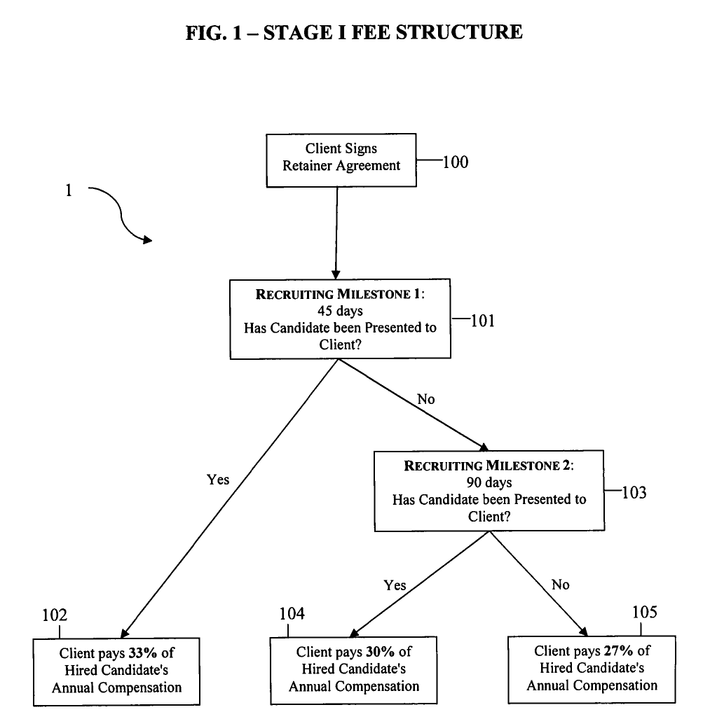

Turning now to the drawings, FIG. 1 illustrates one embodiment of a Stage I fee structure 1. At step 100, a client signs a retainer agreement and the searcher begins a candidate search. At step 101, the first recruiting milestone occurs. In FIG. 1, the first recruiting milestone is indicated to occur forty-five days after the signing of the retainer agreement, but any other time period may alternatively be specified. If the client ultimately hires a candidate who was presented to the client by the searcher by the time the first recruiting milestone is reached, then, as per step 102, the client shall pay the searcher a percentage, such as 33%, for example, of the hired candidate's annual compensation.

If, conversely, the client has not yet been presented with a candidate at the time the first recruiting milestone is reached, the executive search continues until, at step 103, the second recruiting milestone is reached. If the client ultimately hires a candidate who was presented to the client by the searcher after the first recruiting milestone is reached, but by the time the second recruiting milestone is reached, then, as per step 104, the client shall pay the searcher a lower percentage, such as 30%, for example, of the hired candidate's annual compensation. If the client has not been presented with a candidate at the time the second recruiting milestone is reached, then, as per step 105, the client shall pay the searcher a lower percentage, such as 27%, for example, of the presented candidate's annual compensation upon hiring of the candidate.

Any suitable percentages may be assigned for presenting a candidate who is ultimately hired before the first recruiting milestone, before the second recruiting milestone, and after the second recruiting milestone. For example, upon presenting a candidate by the time the first recruiting milestone is reached, the client could be required to pay the searcher between approximately 30-40% of the hired candidate's annual compensation. Upon presenting a candidate by the time the second recruiting milestone is reached, the client could be required to pay the searcher between approximately 25-35% of the hired candidate's annual compensation. If a candidate is not presented until after the second recruiting milestone is reached, the client could be required to pay the searcher between 20-30% of the hired candidate's annual compensation. Any other suitable percentages could alternatively be specified.

In one embodiment, the first recruiting milestone occurs at approximately forty-five days after signing of the retainer agreement, and the second recruiting milestone occurs at approximately ninety days after signing of the retainer agreement. Any other suitable milestone time periods could alternatively be assigned. Furthermore, additional recruiting milestones could be specified as part of Stage I. For example, three or more recruiting milestones could be specified as part of Stage I. For ease of description, however, in the embodiments described herein, Stage I will include two recruiting milestones.

In one embodiment, if a candidate hired by the client was identified by the client, or by another entity other than the searcher, during a period when the signed retainer agreement was in effect, the candidate shall be treated as if presented by the searcher after the second (or final) recruiting milestone. Thus, in the example shown in FIG. 1, the searcher would be paid 27% of the hired candidate's annual compensation in such a scenario.

In another embodiment, if a client hires a fall-off candidate, the client shall pay the searcher a percentage, approximately 15-30%, for example, of the hired fall-off candidate's annual compensation. In one embodiment, if a client hires a fall-off candidate, the client shall pay the searcher approximately 25% of the hired fall-off candidate's annual compensation.

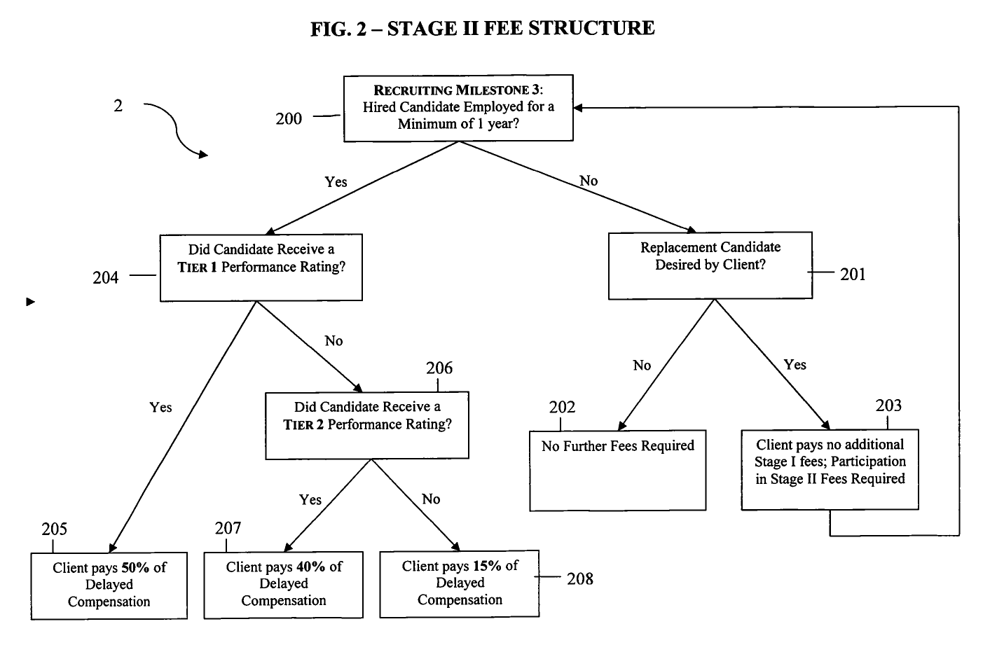

FIG. 2 illustrates one embodiment of a Stage II fee structure 2. At step 200, the third recruiting milestone occurs when a hired candidate has been employed for a minimum time period, one year, for example, and receives a candidate performance rating following a full performance review cycle. If a hired candidate does not remain employed by the client for the minimum time period, then, at step 201, it is determined whether or not the client wants to hire a replacement candidate. If the client does not want to hire a replacement candidate, then no further fees under the Stage II fee structure 2 are required to be paid to the searcher. If the client requests a replacement candidate, the client would not be required to pay any fees under the Stage I fee structure 1 for the replacement candidate, but would be subject to the Stage II fee structure once the replacement candidate reaches his or her own third recruiting milestone, for example, once the replacement candidate has been employed for a minimum time period, one year, for example, and receives a candidate performance rating following a full performance review cycle.

If a hired candidate has been employed for the minimum time period and receives a candidate performance rating, then, at step 204, it is determined whether or not the candidate performance rating is a Tier 1 rating. If the hired candidate receives a Tier 1 candidate performance rating, then, as per step 205, the client shall pay the searcher a percentage, 50%, for example, of the hired candidate's delayed compensation. If the hired candidate receives a Tier 2 candidate performance rating, then, as per steps 206 and 207, the client shall pay the searcher a lower percentage, 40%, for example, of the hired candidate's delayed compensation. If the hired candidate receives a candidate performance rating lower than Tier 2, then, as per step 208, the client shall pay the searcher a lower percentage, 15%, for example, of the hired candidate's delayed compensation. Any other suitable number of tiers and corresponding percentages may alternatively be used. In one embodiment, if a hired candidate does not attain a minimum specified tier rating, the client may not be required to pay any percentage of the hired candidate's delayed compensation, if any is given.

In one embodiment, if a client hires a fall-off candidate, and that fall-off candidate is employed for a predetermined minimum amount of time, for example, one year, and the fall-off candidate receives a Tier 1 candidate performance rating, the client shall pay the searcher a percentage, approximately 40%, for example, of the hired fall-off candidate's delayed compensation. If the fall-off candidate has been employed for one year and receives a Tier 2 candidate performance rating, the client shall pay the searcher a lower percentage, approximately 30%, for example, of the hired fall-off candidate's delayed compensation. If the hired fall-off candidate has been employed for a one year and receives a candidate performance rating lower than Tier 2, the client shall pay the searcher a lower percentage, 10% or less, for example, of the hired fall-off candidate's delayed compensation.

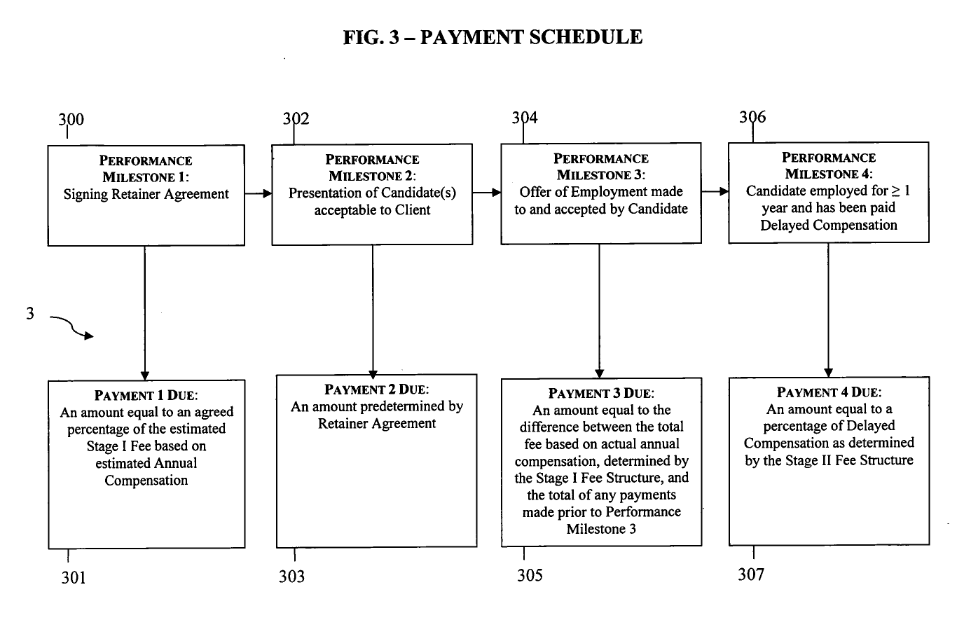

FIG. 3 illustrates one embodiment of a recruitment compensation payment schedule 3. The payment schedule is based on performance milestones met by the searcher. Payment 1, as shown at step 301, is due at the first performance milestone 300, which occurs when a client signs a retainer agreement with a searcher. Payment 1 is optionally an amount equal to a percentage of an estimated annual compensation, which is preferably predetermined by the retainer agreement. Payment 2, as shown at step 303, is due at the second performance milestone 302, which occurs when the searcher presents information about one or more valid candidates to the client. Payment 2 is preferably an amount predetermined by the retainer agreement.

Payment 3, as shown at step 305, is due at the third performance milestone 304, which occurs when an offer of employment by the client is accepted by a presented candidate. The third performance milestone optionally occurs when a hired candidate begins working. Payment 3 is an amount equal to the difference between the total fee based on actual annual compensation, determined by the Stage I Fee Structure 1, and the total of any payments made prior to the third performance milestone 304. Payment 4, as shown at step 307, is due at the fourth performance milestone 306, which occurs when a hired candidate is employed for a predetermined minimum amount of time, for example, one year, and has been paid delayed compensation. Payment 4 is an amount equal to a percentage of delayed compensation as determined by the Stage II Fee Structure 2.

In another embodiment, a computer-readable medium, such as a magnetic disk, a hard drive disk, an optical disk such as a readable, writeable, or re-writable compact disk, a digital video disk such as a readable, writeable, or rewritable digital video disk, a magneto-optical disk, a read-only memory device, a random access memory device, a magnetic card, an optical card, a solid-state memory device such as a flash memory, an EPROM, an EEPROM, and so forth, is used to determine and track compensation for a searcher. The contents of the computer readable medium are preferably capable of processing a series of data related to the search, calculating an annual compensation fee rate and an annual compensation payment schedule, and calculating a delayed compensation fee rate, based on data entered into the user interface.

In some embodiments, the data to be processed includes the date the retainer agreement is signed, the annual compensation to be paid to the hired candidate, the date when an offer of employment is accepted by a candidate, a candidate performance rating, or a delayed compensation to be paid. The contents of the computer readable medium may optionally perform any of the steps described above with respect to the Stage I and 11 fee structures and the payment schedule.

In some embodiments, the annual compensation fee rate is a percentage of a candidate's annual compensation that depends on the time elapsed between the signing of the retainer agreement and acceptance of an offer for employment by the candidate. The annual compensation payment schedule may be based on a set of recruiting milestones to be met by the searcher, as described above.

In some embodiments, the recruiting milestones for the annual compensation payment schedule include signing of the retainer agreement, presentation of one or more valid candidates, and successful hiring of one or more valid candidates.

In some embodiments, the delayed compensation fee rate is a percentage of delayed compensation depending on a candidate performance rating given after a full performance review cycle and is due at the time the candidate is paid delayed compensation. In some embodiments, a full performance review cycle is approximately one year.

In one embodiment, a recruiting compensation system may be used to determine a fee structure and payment schedule for compensating a searcher. Some embodiments of such a system may include a written record system, a paper filing system, a computer program capable of storing data, a computer readable medium, a network, or any other feasible way to record, store, calculate, and process data. Some embodiments of the system include a pre-printed summary or tabular forms, a printer connected to a computing system, a website that allows a user to view the status of an agreement, a network of interconnected computer systems or any other suitable mechanism. The system may optionally be capable of generating an electronic or hard copy summary or report reflecting the status of a retainer agreement, client data, fee structures, payment schedules, searcher compensation, or any other suitable data. Such a summary or report may be used for billing or invoice purposes, or for any other suitable purpose.

### EXAMPLE 1

Table 1 displays exemplary data corresponding to one embodiment of a searcher compensation model. Any other numbers or percentages could alternatively be used based on a searcher's agreement with a client.

TABLE 1
Searcher Compensation Model

| | | | Stage I | Actual | % | | Stage II | Total |
|---|---|---|---|---|---|---|---|---|
| CPR* | AC** | Stage I % | Fee | DC*** | AC | Stage II % | Fee | Fee |
| Tier 1 | $300,000 | 33% | $99,000 | $150,000 | 50% | 50% | $75,000 | $174,000 |
| | | 30% | $90,000 | | | | $75,000 | $165,000 |
| | | 27% | $81,000 | | | | $75,000 | $156,000 |
| Tier 2 | $300,000 | 33% | $99,000 | $90,000 | 30% | 40% | $36,000 | $135,000 |
| | | 30% | $90,000 | | | | $36,000 | $126,000 |
| | | 27% | $81,000 | | | | $36,000 | $117,000 |
| Tier 3 | $300,000 | 33% | $99,000 | $45,000 | 15% | 15% | $6,750 | $105,750 |
| | | 30% | $90,000 | | | | $6,750 | $96,750 |
| | | 27% | $81,000 | | | | $6,750 | $87,750 |

*CPR is Candidate Performance Rating
**AC is Annual Compensation
***DC is Delayed Compensation

In this example, a client signs a retainer agreement with a searcher to conduct a candidate search. The annual compensation for a prospective candidate for the position to be filled is $300,000. If a candidate, who is ultimately hired, is presented to the client by the first recruiting milestone, the client pays the searcher a Stage I fee of 33% of the candidate's annual compensation (i.e., the annual compensation fee rate), totaling $99,000. If a candidate, who is ultimately hired, is not presented by the first recruiting milestone, but is presented by the second recruiting milestone, the client pays the searcher a Stage I fee of 30% of the candidate's annual compensation, totaling $90,000. If a candidate, who is ultimately hired, is not presented until after the second recruiting milestone, the client pays the searcher a Stage I fee of 27% of the candidate's annual compensation, totaling $81,000.

If and when a hired candidate is employed for at least one year and receives a candidate performance rating, a delayed compensation is paid to the candidate. If a hired candidate receives a Tier 1 candidate performance rating, the client pays the searcher 50% of the candidate's delayed compensation (i.e., the delayed compensation fee rate), totaling $75,000 based on an actual delayed compensation that is 50% of the candidate's annual compensation. If a hired candidate receives a Tier 2 candidate performance rating, the client pays the searcher 40% of the candidate's delayed compensation, totaling $36,000 based on an actual delayed compensation that is 30% of the candidate's annual compensation. If a hired candidate receives a Tier 3 candidate performance rating, the client pays the searcher 15% of the candidate's delayed compensation, totaling $6,750 based on an actual delayed compensation that is 15% of the candidate's annual compensation.

Any of the above-described embodiments may be used alone or in combination with one another. Furthermore, the recruiting compensation model may include additional steps or features not described herein. While several embodiments have been shown and described, various changes and substitutions may of course be made, without departing from the spirit and scope of the invention. The invention, therefore, should not be limited, except by the following claims and their equivalents.

What is claimed is:

1. A computer-readable medium, the contents of which are capable of causing a computing system to perform a method for determining searcher compensation, the method comprising:
processing, for each retainer agreement signed between a client and the searcher, the following:
a date the retainer agreement was signed;
a date a candidate accepted an offer of employment;
an annual compensation to be paid to the candidate;
a candidate performance rating, wherein the candidate performance rating is determined after the candidate has been employed for a predetermined term; and
a delayed compensation to be paid to the candidate after the predetermined term of employment has elapsed, wherein the amount of the delayed compensation is dependent on the candidate performance rating;
determining an annual compensation fee rate, wherein the annual compensation fee rate is a percentage of the annual compensation that depends on the time elapsed between the date the retainer agreement was signed and the date the candidate was presented to the client;
determining a delayed compensation fee rate, wherein the delayed compensation fee rate is a percentage of the delayed compensation that depends on the candidate performance rating; and
calculating the searcher compensation based on the annual compensation fee rate and the delayed compensation fee rate.

2. The computer-readable medium of claim 1 wherein the performance rating comprises one of at least a Tier 1 performance rating and a Tier 2 performance rating.

3. The computer-readable medium of claim 2 wherein the delayed compensation fee rate is between approximately 40-50% of the delayed compensation if the candidate receives a Tier 1 candidate performance rating, between approximately 15-40% of the delayed compensation if the candidate receives a Tier 2 candidate performance rating, and 15% of the delayed compensation or less if the candidate receives a candidate performance rating lower than Tier 2.

4. The computer-readable medium in claim 2 wherein the delayed compensation fee rate is approximately 50% of the delayed compensation if the candidate receives a Tier 1 candidate performance rating, approximately 40% of the delayed compensation if the candidate receives a Tier 2 candidate performance rating, and approximately 15% or less of the delayed compensation if the candidate receives a candidate performance rating lower than Tier 2.

5. The computer-readable medium of claim 1 wherein the searcher compensation comprises the sum of the following:
the product of the annual compensation fee rate and the annual compensation, and
the product of the delayed compensation fee rate and the delayed compensation.

6. The computer-readable medium of claim 1 wherein the annual compensation fee rate is between approximately 30-40% of the annual compensation if the candidate is presented within approximately 45 days from the date the retainer agreement was signed, between approximately 25-35% of the annual compensation if the candidate is presented within approximately 90 days from the date the retainer agreement was signed, and between approximately 20-30% of the annual compensation if the candidate is presented after approximately 90 days from the date the retainer agreement was signed.

7. The computer-readable medium of claim 1 wherein the annual compensation fee rate is approximately 33% of the annual compensation if the candidate is presented within approximately 45 days from the date the retainer agreement was signed, approximately 30% of the annual compensation if the candidate is presented within approximately 90 days from the date the retainer agreement was signed, and approximately 27% of the annual compensation if the candidate is presented after approximately 90 days from the date the retainer agreement was signed.

8. The computer-readable medium of claim 1 wherein the method further comprises generating an annual compensation payment schedule that is based on a plurality of recruiting milestones to be met by the searcher, wherein the recruiting milestones comprise signing the retainer agreement, presenting of one or more candidates, and successful hiring of one or more candidates by the client.

9. A method for compensating a searcher that presents a candidate for hire to a client, wherein the candidate receives annual compensation and is eligible for delayed compensation, comprising:
calculating a Stage I searcher fee based on a Stage I percentage of the candidate's annual compensation, wherein the Stage I percentage comprises a first percentage if the candidate is presented to the client by a first predetermined date, and a second percentage if the candidate is presented to the client by a second predetermined date;
calculating a Stage II searcher fee based on a Stage II percentage of the candidate's delayed compensation, wherein the Stage II percentage is based on a candidate performance rating that is given after the candidate has been employed for a predetermined amount of time; and
compensating the searcher with the Stage I searcher fee and the Stage II searcher fee.

10. The method of claim 9 further comprising providing a payment schedule based on a set of performance milestones, wherein a first performance milestone occurs at the time the client signs a retainer agreement, a second performance milestone occurs at the time the searcher presents the candidate to the client, a third performance milestone occurs at the time the candidate accepts an offer of employment, and a fourth performance milestone occurs when the candidate has been employed for the predetermined amount of time

11. The method of claim 9 wherein the Stage I percentage is between approximately 30-40% of the annual compensation if the candidate is presented by the first predetermined date, between approximately 25-35% of the annual compensation if the candidate is presented by the second predetermined date, and between approximately 20-30% of the annual compensation if the candidate is presented after the second predetermined date.

12. The method of claim 9 wherein the Stage II percentage is between approximately 40-50% of the delayed compensation if the candidate receives a Tier 1 candidate performance rating, between approximately 15-40% of the delayed compensation if the candidate receives a Tier 2 candidate performance rating, and 15% or less of the delayed compensation if the candidate receives a candidate performance rating lower than Tier 2.

13. The method of claim 9 wherein the first predetermined date occurs approximately 45 days after signing of a retainer agreement, and the second predetermined date occurs approximately 90 days after signing of the retainer agreement.

14. A searcher compensation modeling system, comprising:
means for receiving a series of data;
means for calculating a Stage I searcher fee based on a Stage I percentage of a candidate's annual compensation, wherein the Stage I percentage comprises a first percentage if the candidate is presented to a client by a first predetermined date, and a second percentage if the candidate is presented to a client by a second predetermined date;
means for calculating a Stage II searcher fee based on a Stage II percentage of the candidate's delayed compensation, wherein the Stage II percentage is a function of a candidate performance rating that is given after the candidate has been employed for a predetermined amount of time;
means for preparing a payment schedule; and
means for generating a report to reflect the status of the payment schedule.

15. The system of claim 14 wherein the series of data comprises at least one of the date of a signed retainer agreement, an annual compensation amount to be paid to a hired candidate, a presented candidate hire date, a candidate performance rating, and a delayed compensation to be paid to a hired candidate who has been employed for the predetermined amount of time.

16. The system of claim 14 wherein the Stage I percentage is between approximately 30-40% of the annual compensation if the candidate is presented by the first predetermined date, between approximately 25-35% of the annual compensation if the candidate is presented by the second predetermined date, and between approximately 20-30% of the annual compensation if the candidate is presented after the second predetermined date.

17. The system of claim 14 wherein the Stage II percentage is between approximately 40-50% of the delayed compensation if the candidate receives a Tier 1 candidate performance rating, between approximately 15-40% of the delayed compensation if the candidate receives a Tier 2 candidate performance rating, and 15% or less of the delayed compensation if the candidate receives a candidate performance rating lower than Tier 2.

18. The system of claim 17 wherein the Stage II percentage is approximately 50% of the delayed compensation if the candidate receives a Tier 1 candidate performance rating, approximately 40% of the delayed compensation if the candidate receives a Tier 2 candidate performance rating, and approximately 15% of the delayed compensation if the candidate receives a candidate performance rating lower than Tier 2.

19. The system of claim 14 wherein the payment schedule is based on performance milestones, wherein a first performance milestone occurs at the time the client signs a retainer agreement, a second performance milestone occurs at the time the searcher presents the candidate to the client, a third performance milestone occurs at the time the candidate accepts an offer of employment, and a fourth performance milestone occurs when the candidate has been employed for the predetermined amount of time.

20. The system of claim 14 further comprising means for generating invoices for the Stage I searcher fees and the Stage II searcher fees.
